(19) United States
(12) Patent Application Publication
(10) Pub. No.: US 2025/0091885 A1
(43) Pub. Date: Mar. 20, 2025

(54) METHOD FOR SYNTHESIZING DIBORIDE POWDER BY DRY ROUTE

(71) Applicant: SAINT-GOBAIN CENTRE DE RECHERCHES ET D'ETUDES EUROPEEN, COURBEVOIE (FR)

(72) Inventors: Mangesh Ramesh AVHAD, CAVAILLON CEDEX (FR); Laurie SAN-MIGUEL, CAVAILLON CEDEX (FR); Thibault CHAMPION, CAVAILLON CEDEX (FR)

(21) Appl. No.: 18/728,239

(22) PCT Filed: Jan. 10, 2023
(86) PCT No.: PCT/FR2023/050036

§ 371 Date: Jul. 11, 2024

(30) Foreign Application Priority Data
Jan. 11, 2022 (FR) 2200195

(51) Int. Cl. C01B 35/04; C04B 35/58

(52) U.S. Cl. CPC C01B 35/04; C04B 35/58071; C01P 2004/51; C01P 2004/61; C01P 2004/62; C01P 2006/80; C04B 2235/3813; C04B 2235/5436; C04B 2235/5445; C04B 2235/6581

(57) ABSTRACT

A method for manufacturing a diboride powder MB₂ by dry route where M is a chemical element belonging to group 4 of the periodic table, from the reduction of an oxide MO₂ of the element M according to the balance reaction MO₂+B₂O₃+yR+xA₂O→MB₂+A₂ₓR_{Y}O₅₊ₓ, wherein R is a reducing element selected from Al, Si, Ti, Zr, Hf, Y, Sc, and the lanthanides and A₂O is an oxide of alkali element A.

The invention relates to a new method for manufacturing or synthesizing diboride of group 4 elements of the periodic table, in particular of titanium diboride.

Diborides of group 4 elements of the periodic table, in particular titanium diboride, zirconium diboride or hafnium diboride, have many advantages, including high refractoriness, high toughness, and excellent chemical inertia.

Titanium diboride in particular is a ceramic material having a low density (about 4.5 g/cm³), a high hardness, a high thermal conductivity and a low electrical resistivity. This makes it a potentially interesting material for several applications, such as refractory applications where the thermal conduction and the high electrical conduction are an asset, in particular heat exchangers, the coating or even the composition of anodes or of cathodes of electrolysis reactors, or even membranes in certain temperature applications or in very aggressive chemical media, as well as the cutting tools of metals, in particular for non-ferrous metals, or cutting tools or shielding or anti-abrasion coating.

All these applications explain that the demand for this material is very high and currently increasing.

Diborides do not exist in the natural state. Titanium diboride can particularly be obtained for example by direct reaction of titanium (or its oxides or hydrides) with elemental boron at 1,000° C. or by carbothermic reduction of titanium oxide and boron oxide. In the latter case, the reaction consists of reacting a mixture of powders according to the following simplified reaction at a temperature above 1500° C.:

TiO₂(s)+B₂O₃(s)+5C(s)→TiB₂(s)+5CO(g) (1)

However, this method has a theoretical material efficiency of about 30%.

Another less known method consists in particular in replacing the boron oxide powder with boron carbide, as shown by the following balance reaction:

2TiO₂+B₄C+3C→2TiB₂+4CO (2)

The advantage of such a reaction is its higher theoretical material efficiency (55.4%) and therefore lesser release of carbon monoxide but it has the disadvantage of requiring a reaction temperature greater than 1600° C. and generates a non-negligible amount of CO in gaseous form, which poses problems of hygiene, safety and environment.

Furthermore, methods for manufacturing this material are all the more expensive and energy-consuming as the desired final powder of titanium diboride becomes finer (typically with a median diameter between 5 and 50 micrometers) or ultra-fine (median diameter less than 5 micrometers).

Another known solution consists of metallothermic reduction using, in place of the carbon, an element in metal form such as Al, Si, Mg, Ca. The exothermic reactions associated with the use of these reagents produce diborides by self-propagating high temperature synthesis (SHS) but lead to the incomplete conversion of reagents, which conventionally requires a second reaction typically with boric acid H₃BO₃ to obtain a better rate of conversion to diboride.

Another solution also consists of synthesis in a mixture of salts that are molten or in solution. The published patent application under WO2020073767A1 from the Wuhan University of Science and Technology thus proposes a method for preparing a layer of TiB2 or (Zr, Hf)B2 that is less expensive and more environmentally sound, from a mixture comprising a source of titanium (or zirconium or hafnium), a source of boron, a reducing agent (Si or Al in metallic form), and an alkali salt. The alkali salt may be chosen from a hydrate, a silicate or a carbonate of sodium, of lithium or of potassium in order to form a liquid phase at low temperature. The addition of silicate, however, leads to reaction products that are difficult to separate. Adding carbonate(s) poses the problem of C02 release due to the decomposition of the carbonate during the synthesis reaction.

The purpose of the invention is thus to improve the synthesis methods described above in order to obtain a diboride powder of a group 4 element of the periodic table, in particular of TiB₂, that is:
fine, i.e. typically a powder with a median diameter of between 0.5 and 50 microns;
of better purity, that is, whose elemental mass content as the sum of the following contaminants: oxygen (O), sulfur (S), carbon (c), nitrogen (N), iron (Fe), phosphorus (P), silicon (Si) and/or aluminum (Al), in particular in metal form, cobalt (Co), nickel (Ni), alkali metals (Li+Na+K+Rb+Cs), alkaline earth metals (Be+Mg+Ca+Sr+Ba) is less than 5%, and preferably, that is, the total elemental mass content of contaminants is less than 3%, or less than or equal to 2%; while having:
satisfactory material efficiency, for example at least 20%;
easy ability to extract said diboride powder from reaction products;
very low, preferably no, release of CO or C02, and
without resorting to an industrial process that is too complex for the synthesis of powder.

### SUMMARY OF THE INVENTION

In particular, according to a first aspect, the present invention relates to an alternative method for manufacturing a diboride powder of a group 4 element of the periodic table, in particular titanium diboride TiB₂, at a temperature of less than 1500° C., preferably less than 1400° C., preferably less than 1300° C., or even 1200° C., for this purpose by virtue of an appropriate choice of starting powders, without the use of solvent or surfactant.

More specifically, the present invention relates to a method for manufacturing a diboride powder MB₂, where M is a chemical element belonging to group 4 of the periodic table, by reducing an oxide MO₂ of said element M, said method comprising the following steps:
preparing a mixture of raw materials comprising, and preferably consisting of:
a) a powder whose mass content of said oxide MO₂ is at least 95% and
b) a powder comprising a boron oxide or a precursor of a boron oxide, the boron content of which, expressed in B₂O₃, is at least 30%; and
c) a metal powder of at least one reducing element R, R being selected from Al, Si, Ti, Zr, Hf, Y, Sc, the lanthanides; and
d) an oxide powder of an alkali element A, having a A₂O mass content of at least 70%,
in the respective proportions leading, preferably corresponding, to the following balance reaction, expressed according to said MO₂, B₂O₃, R and A₂O:

MO₂+B₂O₃+yR+xA₂O→MB₂+A₂ₓR_{y}O₅₊ₓ (3)
heating said mixture in an enclosure under a rare gas flow, at a temperature above 600° C. and below 1500° C., in order to obtain the compound MB₂, said mixture of raw materials having the following characteristics:
the median particle diameter of said powder comprising the oxide MO₂ is between 1 and 100 microns, and
the median particle diameter of the powder comprising a boron oxide or a boron oxide precursor is between 5 and 200 microns; and
x is greater than or equal to 1
y is greater than 0.5.

According to preferred but non-limiting embodiments of the present invention, which can, if appropriate, be combined with one another:
The mass sum of the powder whose mass content of said oxide MO₂ is at least 95%, of the powder comprising a boron oxide or a boron oxide precursor, of the metal powder of at least one reducing element R, and of the oxide powder of alkali element A, represent more than 80% by weight of said mixture, or even for more than 90% by weight, or even more than 95% by weight of said mixture.
The powder whose mass content of the oxide MO₂ is at least 95% comprises a plurality of MO₂ oxides, in particular is a mixture of TiO₂, ZrO₂ and/or HfO₂.
The powder whose mass content of said oxide MO₂ is at least 95% comprises a mixed oxide with at least two different elements M, M being chosen from Ti, Zr and Hf,
The powder consists of oxide MO₂, preferably consists of titanium oxide.
The powder comprises a boron oxide or a precursor of a boron oxide, the boron mass content of which, expressed as B₂O₃, is at least 40%.
The metal powder comprises at least one reducing element R selected from the element aluminum (Al) and/or silicon (Si).
The oxide powder of alkali element A, preferably sodium oxide (Na₂O), has a mass content of A₂O is at least 80%
The content of hydroxyl (OH) of the oxide powder of alkali element A, calculated in the form of the mass of OH to the mass A₂O is preferably less than 30%, more preferably less than 20%, or even less than 10%, or even less than 5% or even substantially zero.
The flow rate of the gas flow in said enclosure being between 0.5 and 10 L/min per m³ of enclosure.
The median particle diameter of said powder comprising oxide MO₂ is between 30 and 100 micrometers, more preferably between 30 and 50 micrometers.
The median particle diameter of the powder comprising boron oxide is between 10 and 100 microns.
the total content of said mixture of alkali oxide raw materials, calculated in the form A₂O, is equal to or greater than the amount necessary for said reaction (3), such that x is greater than 1, preferably x is between 1.5 and 5, more preferably x is between 1.5 and 2.
the residual mass content H₂ of said mixture of raw materials is less than 5%, as measured at a temperature of 400° C. at atmospheric pressure.
y is greater than 1.

According to one possible embodiment, the mixture of raw materials comprises an oxide powder MO₂ of a first chemical element M belonging to group 4b of the periodic table and a second oxide powder MO₂ of a second chemical element M belonging to group 4b of the periodic table different from the first element, M being chosen from Ti, Zr, or HfO₂.

According to another embodiment, which can be combined with the preceding one, the mixture of raw materials comprises at least one oxide powder MO₂ wherein M is a mixture of at least two, preferably two, chemical elements belonging to group 4b of the periodic table.

As will be described in more detail below, such a combination of parameters advantageously makes it possible to obtain a fine powder of MB₂ diboride of high purity with a satisfactory material efficiency, using a method that releases little or no CO or CO₂ and allows for easy ability to extract said diboride powder without using an excessively industrially complex powder synthesis method.

The respective proportions leading to the reduction of the oxide of element M into diboride of element M are the substantially stoichiometric amounts of the various reagents mentioned in the preceding points a) to d) leading to the balance reaction (3).

For example, in the case of the use of a lithium oxide precursor of the type Na₂B₄O₇, one mole of B₂O₃ in the reaction (3) corresponds to an addition of a half-mole of the reagent Na₂B₄O₇.

Thus, the balance reaction (3) is written, in the case of the use of boron oxide B₂O₃:

MO₂+B₂O₃+R+xA₂O→MB₂+A₂ₓRO₅₊ₓ

The balance reaction (3) is written, in the case of the use of a boron oxide precursor Na₂B₄O₇:

MO₂+B₂O₃+yR+xA₂O→MB₂+A₂ₓR_{y}O₅₊ₓ

where M=Ti A=Na R=Al x=5/3 and y=10/3

In particular, unlike the synthesis methods using molten salts or placing in a solution of a solvent, in particular water, the method according to the invention by dry route and in particular by the use of an oxide powder of a weakly or non-hydroxylated alkaline element A rather than the use of an alkali salt in solution as is described, for example, by WO2020073767A1, advantageously allows an optimal reaction, that is to say with a maximum material balance, while allowing easy separation of the diboride powder of element M after synthesis in the enclosure.

According to other preferred embodiments of the present invention, which can, if appropriate, be combined with one another:
The boron oxide precursor is chosen from compounds wherein the boron is in a non-carbide, non-metallic form and in a form other than a salt, and in particular other than that of a halide, for example boron nitride.
The boron oxide is chosen from B₂O₃, sodium metaborate of chemical formula NaBO₂, anhydrous borax of formula Na₂B₄O₇, or other borates such as natural borax of formula Na₂B₄O₇·10H₂O, tincalconite of formula Na₂B₄O₇·5H₂O, kernite of formula Na₂B₄O₇·4H₂O, ulexite of formula NaCaB₅O₉·8H₂O, proberite NaCaB₅O₉·5H₂O, sassolite of formula H₃BO₃. Preferably, the boron oxide is chosen from sodium metaborate of chemical formula NaBO₂, anhydrous borax of formula Na₂B₄O₇, or other borates such as natural borax of formula Na₂B₄O₇·10H₂O, tincalconite of formula Na₂B₄O₇·5H₂O, kernite of formula Na₂B₄O₇·4H₂O, ulexite of formula NaCaB₅O₉·8H₂O, proberite NaCaB₅O₉·5H₂O;
The powder comprising boron oxide is an anhydrous alkali borate powder, preferably an anhydrous soda borate powder.
The median diameter (D₅₀) of particles of said powder comprising the oxide MO₂ is greater than 7 micrometers, preferably greater than or equal to 10 micrometers and/or less than 50 micrometers, or even less than 30 micrometers.
The diameter D₅₀ of particles of said powder comprising the oxide MO₂ is less than 100 micrometers, preferably less than 80 micrometers, preferably less than or equal to 50 micrometers, more preferably less than or equal to 40 micrometers,
The median diameter (D₅₀) of particles of said powder comprising boron oxide is greater than 10 micrometers, preferably greater than or equal to 30 micrometers and/or less than 100 micrometers, or even less than 50 micrometers.
The median diameter (D₅₀) of particles of said reducing metal powder R is greater than 10 micrometers, preferably greater than or equal to 30 micrometers and/or preferably less than 100 micrometers, preferably less than 50 micrometers, or even less than 30 micrometers.
The oxide powder of alkali element A is a powder in the form of granules whose size is greater than 30 micrometers and/or less than 100 micrometers.
The ratio of the median particle diameter of said powder comprising boron oxide to the median particle diameter of the said metal oxide powder M is less than 30, preferably less than or equal to 10 and/or greater than 5, preferably greater than 2. This ratio makes it possible to optimize the conversion rate into diboride of element M.
The ratio of the median particle diameter of said powder comprising boron oxide to the median particle diameter of said powder comprising the oxide M₂ is less than 10 and/or greater than 1.
A is the element Na.
R is the element Al and/or Si
M is the element Ti, A is the element Na and R is the element Al and/or Si.
The powder comprising the oxide MO₂ is a titanium oxide powder, preferably a rutile or anatase powder, even more preferably rutile.
The mass content of SiO₂+Al₂O₃+Fe2O3+Na2O+K2O+CaO+MgO in the powder comprising the oxide MO₂, preferably titanium oxide, is less than 5%. In particular, the mass content of SiO₂ in the powder comprising the oxide MO₂, preferably titanium oxide, is preferably less than or equal to 2%. The mass content of Al₂O₃ in said powder comprising the oxide MO₂, preferably titanium oxide, is preferably less than or equal to 2%. Preferably, the mass content of Fe2O3+Na2O+K2O+CaO+MgO in said powder comprising the oxide MO₂, preferably titanium oxide, is preferably less than or equal to 1%. Preferably, the mass content of the sum of the carbon elements (C)+nitrogen (N) in said powder comprising the oxide MO₂, preferably titanium oxide, is preferably less than or equal to 1%, preferably less than or equal to 0.5%.
Apart from the reducing metal powder R which may contain this element when it is in particular silicon powder, the mass content of the element silicon (Si), expressed in the form of SiO₂, in the mixture of raw materials before reaction is preferably less than 2%, preferably less than 1%.
The raw materials were dried beforehand at a temperature between room temperature and 150° C.
The synthesis temperature, that is the heating temperature in said enclosure, is greater than 700° C., preferably greater than 800° C. and/or less than 1400° C., preferably less than 1300° C., more preferably less than 1200° C.
The pressure of the enclosure is kept virtually constant, for example between 0.5 and 1.5 bars and even more preferably the enclosure is at atmospheric pressure (1 bar).
The gas sweeping the enclosure is preferably a noble gas, for example argon or helium, preferably argon. Preferably, the gas sweeping the enclosure, preferably a noble gas, is brought into the enclosure in contact with the mixture of raw materials. The flow rate is preferably from 0.5 to 5 L/min per m³ of enclosure, preferably between 0.5 and 3 L/min per m³, preferably between 0.5 and 2 L/min per m³ of enclosure. Too low a sweep leads to an incomplete reaction, and more particularly to undesirable residues present in the final powder of diboride MB₂.
An inert sweep non-oxidizing gas flow ratio of 0.005 to 1 L/min per m³ of enclosure and per KW of heating power of the enclosure is particularly optimal, preferably between 0.01 and 0.5/min per m³ of enclosure and per kW of heating power of the enclosure.

After reaction, the finely divided raw diboride powder of group 4 element of the periodic table can be easily extracted from the crude mixture resulting from the enclosure after the heating step.

According to one possible embodiment, a sieving operation, typically to a diameter of 100 micrometers, preferably of 50 micrometers, or even of light crushing or of vibration, makes it possible to eliminate the agglomerates and to separate out the raw powder of diboride of element M. A suspension is carried out by adding to the previously ground crude mixture a solvent, preferably deionized water, in a mass ratio of 1 part crude mixture to at least 20, preferably 50 parts of solvent. Said suspension is filtered to an optimal size typically less than 30 micrometers, preferably less than 20 micrometers in order to allow through the liquid comprising the very fine residues of the other products of the reaction (3). The filtration retentate, consisting of the diboride powder of element M, is then calcined or dried, preferably in air, at a temperature above 80° C., preferably above 100° C. and/or preferably below 300° C., preferably below 200° C., preferably below 150° C.

According to one possible embodiment, said liquid resulting from the filtration of the suspension described above comprising products of the reaction (3) apart from the diboride powder of element M is heat-treated in the presence of water and a basic solution in order to form a hydrate of element R and an alkali hydroxide. This embodiment makes it possible to upgrade the reaction product (3) of formula A₂ₓR_{y}O₅₊ₓ. Preferably, this possible embodiment is particularly advantageous in the case where the element R is Al and the alkali A is sodium.

The invention also relates to a diboride powder of element M of group 4 of the periodic table, in particular a powder of titanium diboride TiB₂, obtained according to the preceding method.

Said powder comprises more than 95% by mass of the compound MB₂, M being selected from Ti, Zr and Hf. The median particle diameter of this powder is between 0.5 and 50 microns, and it further comprises the following mass percents:
elemental oxygen (O): less than 1.3%, preferably less than 1.2%, preferably less than 1% or even less than 0.5%;
elemental carbon (C): less than 0.5%, preferably less than 0.1%;
elemental nitrogen (N): less than 0.5%, preferably less than 0.1%;
elemental sulfur (S): less than 400 ppm, preferably less than 300 ppm or even less than 150 ppm, or even less than 100 ppm or less than 50 ppm;
elemental iron (Fe): less than 0.45%, preferably less than 0.4%;
elemental nickel (Ni): less than 0.4%, preferably 0.2%, or even less than 0.1%;
elemental cobalt (Co): less than 0.4%, preferably 0.2%, or even less than 0.1%;
elemental sum of the alkali metals Li+Na+K+Rb+Cs: less than 1%, preferably less than 0.5%;
elemental sum of the alkaline earth metals (Be+Mg+Ca+Sr+Ba): less than 1%, preferably less than 0.5% or even less than 0.25%;
content of element R in metal form: less than 2%, preferably less than 1%, more preferably less than 0.5%, R preferably being different from M, R being at least one element selected from Al, Si, Ti, Zr, Hf, Y, Sc, the lanthanides, the sum of the other elements being less than 2%, preferably less than 1%.

Preferably, the sum of elemental oxygen (O)+nitrogen (N)+carbon (C) in the diboride powder of element M is less than 1.5%, or even less than or equal to 1.2%.

Preferably, the mass content of silicon (Si) in metal form in the diboride powder of element M is less than 0.1%.

Preferably, the mass content of aluminum (Al) in metal form of the diboride powder of element M is less than 2%, preferably less than 1%, preferably less than 0.5%.

Preferably, the final powder of MB₂ according to the invention does not comprise any crystallized phases such as M₂O₃, M₃B₄ as measured (detectable) by X-ray diffraction. Preferably, said powder comprises only a crystalline phase of MB₂, as measured (detectable) by X-ray diffraction.

Preferably, the ratio (D₉₀−D₁₀)/D₅₀ of equivalent diameter of the particles of the raw powder, i.e. the powder after extraction of the crude mixture from the enclosure after the heating step, in particular after separating the reaction product (3) of formula A₂ₓR_{y}O₅₊ₓ, is less than 2, preferably less than 1.5, more preferably less than 1.2 or even less than 1. The percentiles D₁₀, D₅₀ and D₅₀ being the diameters corresponding respectively to the percentages of 10%, 50% and 90% on the cumulative curve of grain diameter distribution by volume classified in increasing order of said powder.

If M=Ti, the elemental Ti mass content is preferably greater than 68% and/or less than 72% and the elemental boron mass content is preferably greater than 29% and/or less than 33%. Preferably, the elemental phosphorus mass content is less than 0.3%, preferably less than 0.2% or even less than 0.1%.

Such a diboride powder of element M of group 4 of the periodic table, in particular a TiB₂ powder of high purity and of fine, regular particle size makes it possible to obtain by sintering a sintered ceramic body having a total porosity of less than 7% by volume without the use of the addition of transition metals such as Ni, Fe or Co which are capable of resulting in the formation of secondary metal borides from these metals which are not desired.

Such a powder makes it possible to obtain a sintered ceramic body in the form of a part, at least one dimension of which, preferably all of the overall dimensions, is greater than 5 cm, or even greater than 10 cm, and having a total porosity also less than 7%, a very narrow pore size distribution, without deformation on sintering and without shrinkage cracking.

Preferably, M is Ti.

Said diboride powder of element M of group 4 of the periodic table is then a powder of compound TiB₂ which further comprises one or more of the following mass percents:
titanium (Ti): greater than 68% and/or less than 72%,
boron (B): greater than 29% and/or less than 33%,
oxygen (O): less than 1%, preferably less than 0.5%, or sulfur (S) less than 400 ppm, less than 300 ppm, less than 100 ppm, preferably less than 50 ppm,
preferably phosphorus (P): less than 0.3% preferably less than 0.2%, preferably less than 0.1%

Said diboride powder of element M of group 4 of the periodic table is then a powder TiB₂ whose chemical composition comprises the following elemental mass percents:
titanium (Ti): greater than 68% and/or less than 72%,
boron (B): greater than 29% and/or less than 33%,
preferably phosphorus (P) less than 0.3%,
metallic aluminum: less than 2%,
metallic silicon; less than 1%.

The ratio D₉₀−D₁₀)/D₅₀ of equivalent diameter of the particles of the MB₂ powder is advantageously less than 1.5, more preferably less than 1.2 or even less than or equal to 1.0.

The invention also relates to a mixture comprising between 90 and 99.9% by weight of diboride of element M of group 4 of the periodic table or even consisting of a powder of diboride of element M of group 4 of the periodic table, preferably titanium diboride (TiB₂), according to the invention and between 0.1 and 10% by weight of one or more sintering powders selected from powders of aluminum diboride, magnesium diboride, zirconium diboride, tungsten pentaboride, calcium hexaboride, preferably silicon hexaboride, optionally zirconium diboride if M=Ti or Hf, the purity of which is greater than 95% by mass, preferably greater than 98% by mass. A purity greater than 95% by mass is that of said phase or of the most stable main compound: for example, in the case of a powder of aluminum diboride, more than 95% by mass of AlB₂ or for a tungsten pentaboride powder, containing more than 95% by mass of W₂B₅.

The invention likewise relates to a method for manufacturing a sintered ceramic body, comprising the following steps:
a) preparing a starting feedstock including:
   diboride powder of element M of group 4 of the periodic table, preferably of TiB₂ and/or (Zr, Hf)B₂ preferably TiB₂, as obtained by a method according to the invention or a mixture of powders as described above comprising said powder and one or more of said sintering powders.
   an aqueous solvent, in particular deionized water,
   preferably, shaping additives,
b) shaping the feedstock into the form of a preform, preferably by pressing,
c) removal from the mold after setting or drying;
d) optionally, drying the preform, preferably until the residual moisture content is comprised between 0 and 0.5% by weight,
e) loading in a furnace and firing the preform under an inert atmosphere, preferably under argon, or under vacuum, preferably at a temperature between 1600° C. and 2200° C.

The invention also relates to the sintered ceramic body thus obtained and the use of the sintered ceramic body obtained by the preceding method as all or part of a membrane, in particular for the filtration of liquids or gases, a shielding or an anti-abrasion coating, a covering or a refractory block, an anode coating or block or a cathode coating or block, in particular an electrolysis reactor, a heat exchanger, a metal melting crucible, in particular for non-ferrous metal, a cutting tool.

### Definitions

The following indications and definitions are given in connection with the preceding description of the present invention:
In the present description, unless otherwise specified, all the percentages are given by weight, on the basis of dried material.
The term “boron oxide” is understood to mean any oxide comprising boron and oxygen, optionally with at least one other element, in particular chosen from Na, Ca, the oxide being optionally hydrated.
A boron oxide precursor is understood here to mean a powder comprising the element boron (B) which by oxidation, for example by heating in an oxidizing gas, preferably in air, to a temperature of less than 600° C., or by contact with an oxide present in the mixture of raw materials, oxidizes in order to produce the reagent B₂O₃ present in the chemical equation of the reaction (3).
The material efficiency is calculated by dividing the mass of raw diboride powder of element M obtained, divided by that of the dry mixture of reagent powder (moisture less than 5%) before heat treatment.
“Raw mixture” is understood the mixture directly obtained at the outlet of the enclosure after the heating and reaction of the mixture of raw materials and before additional treatment of extracting the raw diboride powder of element M, for example by screening or slight grinding.
The median diameter (or the median “size”) of the particles constituting a powder is given within the meaning of the present invention by characterizing the particle size distribution, in particular by means of a laser particle sizer. The characterization of particle size distribution is conventionally carried out with a laser particle size analyzer in accordance with the ISO 13320-1 standard. The laser particle size analyzer can be, for example, a Partica LA-950 from HORIBA. For the purposes of the present description and unless otherwise mentioned, the median particle diameter respectively denotes the diameter of the particles below which 50% by mass of the population is found. “Median diameter” or “median size” of a set of particles is called a powder, the D₅₀ percentile, that is, the size dividing the particles into first and second populations equal in volume, these first and second populations comprising only particles having a size greater than, or less than, respectively, the median size. It is also possible to determine the percentiles D₁₀ and d₉₀ of a grain or particle powder, which are the diameters corresponding respectively to the percentages of 10% and 90% on the cumulative distribution curve of diameter of grains by volume classified in increasing order.
the contents of elementary chemicals can be determined according to the ISO 21068:2008 standard.

In particular, the following mass contents of:
O, N C, and S are measured by analyzer of the LECO® brand,
Si, Al, Co, Ni, alkali (Li+Na+K+Rb+Cs), alkaline earth (Be+Mg+Ca+Sr+Ba), Fe, P can be determined by ICP (Induction Coupled Plasma),
the contents of element M (in particular Ti, Zr, Hf) are preferably determined by ICP.
Aluminum in metallic form or silicon in metallic form or compound MB₂ can be determined by X-ray diffraction.
the content of hydroxyls (OH) of the oxide powder of alkali element A can be measured by PH-metry.
the actual powder density is measured by helium pycnometry, for example using Micromeritics AccuPyc1330 equipment.
the total porosity of a ceramic body is the ratio, expressed as a percentage, of the bulk density measured for example according to ISO 18754 to the absolute density measured for example according to ISO 5018.

Unless otherwise specified, all percentages in this description are mass percentages.

### FIGURES

FIG. 1 shows the raw powder according to example 2 according to the invention.

FIG. 2 shows the raw powder according to the comparative example 1.

FIG. 3 shows the raw powder of the comparative example 3.

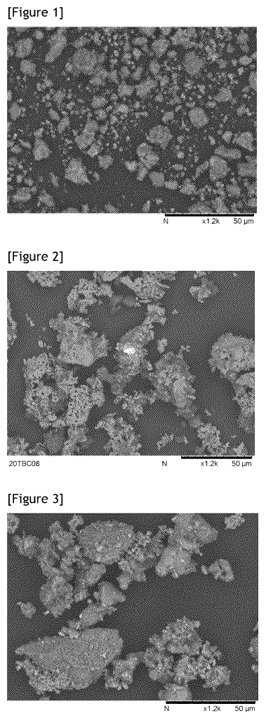

### DETAILED DESCRIPTION

The invention and its advantages will be better understood on reading the detailed description given below. Of course, the present invention is not limited to such a mode, in any of the aspects described below.

The mixture of starting raw materials comprises:
a powder comprising oxide MO₂ (for example a powder of titanium oxide, preferably rutile or anatase), the mass content of MO₂ is at least 95%, and
a powder comprising a boron oxide or a boron oxide precursor, the boron content of which, expressed in B₂O₃, is at least 30%;
a metal powder of a reducing element R chosen from Al, Si, Ti, Zr, Hf, Y, Sc, and the lanthanides, their mixture or their alloy, whose mass content of elements other than Al, Si, Ti, Zr, Hf, Y, Sc, and the lanthanides is less than 1%, preferably less than 0.5%, for example a powder of the element aluminum (Al) and/or of the element silicon (Si), and
an oxide powder of an alkali element A, whose mass content of A₂O is at least 70%, preferably at least 80%, preferably at least 90%, preferably at least 95%, preferably at least 98%, more preferably a powder of sodium oxide (Na₂O) of greater purity of at least 99%,
It is carried out under standard conditions for a person skilled in the art. This step of preparing the dry mixture allows intimate contact of the particles. According to one possible embodiment, it is carried out in a ball mixer or in a tumbler mixer or other devices known to the person skilled in the art. Prior co-grinding can be carried out to adjust the particle size of the starting raw materials if necessary.

If necessary, the certain raw materials such as borates or alkaline element oxide powder can be dried or calcined in order to reduce their H2O or hydroxyl content. In the case of starting materials such as the natural borax of formula Na₂B₄O₇·10H₂O (also expressed in the form Na₂B₄O₅(OH)₄·8H—O), the tinicalite of formula Na₂B₄O₇·5H₂O (also expressed in the form Na₂B₄O₅(OH)₄·3H₂O) the kernite of formula Na₂B₄O₇·4H₂O (also expressed in the form Na₂B₄O₆(OH)₂·3H₂O), the ulexite of formula NaCaB₅O₉·8H₂O (also expressed in the form of NaCaB₅O₆(OH)₆·5H₂O), the probertite NaCaB₅O₉·5H₂O (also expressed in the form of NaCaB₅O₇(OH)₄·3H₂O), this treatment reduces the presence of hydrogen present in the form of water H₂O adsorbed on the surface of the OH powder or hydroxyls. It makes it possible to improve the conversion rate into the diboride of element M, which also results in a raw powder of MB₂ having after synthesis a very low content of reducing metal at element R.

Preferably, in order to maximize the conversion rate into diboride MB₂, the content of hydroxyl (OH) provided by the raw materials in the reaction (3) is minimized. In particular, the borates may be calcined in order to dehydroxylate them. Even more preferably, the oxide powder of alkali element A has a hydroxyl content, calculated by dividing its mass of OH by the mass of alkali metal A₂O, is less than 40%, preferably less than 30%, more preferably less than 20%, or even less than 10%, or even less than 5% or even substantially zero.

The median size or median diameter of the oxide particles of element M is respectively between 1 and 100 microns, preferably between 7 and 80 microns. That of the particles comprising boron oxide, that of the metal particles of reducing element R and that of the oxide particles of alkali element A is preferably between 30 and 100 micrometers, preferably between 30 and 80 micrometers.

Preferably, the median size ratio of the particles comprising boron oxide to those of oxide of element M is between 1 and 10.

Preferably, in a mixture according to the invention comprises in mass proportion respectively 20 to 25% oxide of element M, 25 to 40% powder comprising a boron oxide or a boron oxide precursor, 20 to 30% metal powder of reducing element of element R and 15 to 25% an oxide powder of an alkali element A. In particular, in the case where the element M is Ti and A is Na, the mixture according to the invention respectively comprises, in mass proportion, 20 to 25% titanium oxide, 25 to 35% powder comprising a boron oxide or a boron oxide precursor, preferably sodium borate, 20 to 30% metallic powder of reducing element R, preferably Al and/or Si, and 15 to 25% sodium oxide powder.

The total content of alkali oxide calculated in form A₂O in said mixture of raw materials is greater than or equal to the stoichiometric amount required for said reaction (3), preferably less than 10%, or even less than 5%;

The mixture is preferably dried in air, preferably at a temperature above 40° C., more preferably at a temperature above 100° C., in order to obtain a mixture whose residual moisture content, that is to say the residual mass content of H₂O as measured by a moisture meter well known to a person skilled in the art, said mixture of raw materials is less than 5%, preferably less than 2%, or even more preferably less than 1%.

The mixture is placed in an inert crucible, preferably by diboride of element M or even of alumina, preferably of alumina coated with diboride of element M, for example in an induction furnace. The loose density of the mixture before heat treatment measured according to the ASTM D7481-18 standard is preferably greater than 0.1 times the density of MB₂, or greater than 0.2 and/or preferably less than 0.5, less than 0.3 times the density of MB₂.

A temperature rise is carried out to at least one temperature preferably higher than the melting point of the metal of element R selected from Al, Si, Ti, Zr, Hf, Y, Sc, and the lanthanides, their mixture or their alloy, the content of other elements Al, Si, Ti, Zr, Hf, Y, Sc, and the lanthanides, preferably greater than 600° C., preferably greater than 700° C., preferably greater than 800° C., and less than 1500° C., preferably less than 1300° C., in a non-oxidizing atmosphere, preferably under a flow of rare gas, in particular Argon in order to prevent oxidizing the powder of metal reducer R.

Preferably, the non-oxidizing gas sweeping is carried out at a normal flow rate of 0.5 and 5 L/min per m³ of enclosure, preferably between 0.5 and 3 L/min/m³, preferably between 0.5 and 2 L/min/m³ of enclosure.

Preferably, the temperature rise is less than 20° C./minute, preferably less than 10° C./minute, preferably less than 5° C./minute, or even less than 3° C./minute. This temperature rise ramp, like the duration of the plateau, can be adjusted as a function of the mixing volume and the power of the reactor. In particular, such a temperature rise range promotes better control of the exothermic effect due to the synthesis reaction of the powder according to the invention.

Preferably, the plateau at the maximum temperature is at least one hour, preferably at least two hours.

Preferably, an intermediate plateau is carried out between 60° and 1000° C., and/or a lower ramp, typically at least twice as low, is carried out after 600° C. in order to prevent the removal of the mixture and promote the reaction between the particles.

The cooling can be free or forced, preferably according to a negative ramp less than 20° C./min.

The raw mixture obtained has a particle size of typically between 10 and 100 micrometers.

A sieving operation, typically to a diameter of 100 micrometers, preferably to a diameter of 80 micrometers, preferably to a diameter of 50 micrometers, or even of light crushing or of vibration makes it possible to eliminate the agglomerations and to separate the raw powder of diboride of element M.

According to one possible embodiment, a sieving operation, or even of light crushing or of vibration, makes it possible to eliminate the agglomerates and to separate out the powder of diboride of element M. A suspension is carried out by adding to the previously ground crude mixture a solvent, preferably deionized water, in a mass ratio of 1 part crude mixture to at least 20, preferably 50 parts of solvent. Said suspension is filtered at an optimal size typically at 30 micrometers, preferably 20 micrometers, or 15 micrometers or less in order to allow through the liquid comprising the very fine residues of the other products of the reaction (3). The filtration retentate, consisting of the diboride powder of element M, is then calcined or dried, preferably in air, at a temperature above 80° C., preferably above 100° C. and/or preferably below 300° C., preferably below 200° C., preferably below 150° C.

According to one possible embodiment, said liquid resulting from the filtration of the suspension described above comprising products of the reaction (3) apart from the diboride powder of element M is heat-treated in the presence of water and a basic solution in order to form a hydrate of element R and an alkali hydroxide. This embodiment makes it possible to upgrade the reaction product (3) of formula A₂ₓR_{y}O₅₊ₓ. Preferably, this possible embodiment is particularly advantageous in the case where the element R is Al and the alkali A is sodium.

After grinding the raw powder, it is possible to obtain a final diboride powder of finely divided element M whose median diameter is between 0.5 and 50 micrometers of large purity, of micron size, the size dispersion of which is very small.

The final powder of diboride of element M makes it possible to obtain by sintering a sintered ceramic body having a total porosity of less than 7% by volume without adding transition metals such as Ni, Fe or Co while exhibiting a very low electrical resistivity.

The final powder obtained according to the method of the invention also makes it possible to obtain a sintered ceramic body in the form of a part, all of the dimensions of which are at least one dimension greater than 5 cm without deformation upon sintering and without shrinkage cracking.

The material of the powder according to the invention has an electrical resistivity, measured at 25° C. and at atmospheric pressure, of less than 0.2 microOhm·m.

The electrical resistivity can be measured according to the Van der Pauw method at 4 points on a sample with a diameter of 20-30 mm and a thickness of 2.5 mm. The sample being obtained by pressing a mixture consisting of said powder with 0.25% of a pressing additive (PVA) and 4.75% of deionized water by mass relative to the mass of M diboride powder in order to be cold-pressed under a pressure of 100 bar and to form a cylinder with a diameter of 30 mm and a thickness of 10 mm. After demolding, each cylinder was dried at 110° C. for 24 hours and then fired without pressure at a temperature of 1850° C. for 12 h in Argon.

A method for manufacturing a sintered ceramic body using the powder according to the invention in particular comprises the following steps:
a) preparing a starting feedstock including:
   the diboride powder of element M, where M is a chemical element belonging to group 4 of the periodic table, in particular TiB₂ powder according to the invention or a mixture of powders as described above, comprising said powder and one or more sintering powders, in particular chosen from powders of aluminum diboride, magnesium diboride, tungsten pentaboride, calcium hexaboride, silicon hexaboride, optionally zirconium diboride if M=Ti or Hf, the purity of said MB₂ powder being greater than 95% by mass, preferably greater than 98% by mass, said MB₂ powder preferably representing at least 90% of the total mass of the feedstock.
   an aqueous solvent, in particular deionized water,
i. less than 20% of the total mass of the feedstock in the case of shaping by casting,
ii. less than 15% of the total mass of the feedstock in the case of shaping by extrusion,
iii. less than 10%, preferably less than 7% of the total mass of the feedstock in the case of a press-forming,
   preferably, forming additives such as binders such as PVA (polyvinyl alcohol), plasticizers (such as polyethylene glycol), lubricants,
b) shaping the feedstock into the form of a preform, preferably by pressing, extrusion, or pouring,
c) removal from the mold after setting or drying;
d) optionally, drying the preform, preferably until the residual moisture content is comprised between 0 and 0.5% by weight,
e) loading in a furnace and firing the preform under an inert atmosphere, preferably under argon, or under vacuum, preferably at a temperature between 1600° C. and 2200° C., preferably according to a temperature rise ramp of less than 20° C./minute, preferably less than 10° C./minute. This temperature rise ramp, like the duration of the plateau, can be adjusted as a function of the mixing volume and the power of the reactor.

Any shaping technique known to the person skilled in the art can be applied as a function of the dimensions of the part to be made as soon as all the precautions are taken to avoid contamination of the preform. Thus, the casting in a plaster mold can be adapted by using graphite media between the mold and the preform or oils avoiding excessive contact and abrasion of the mold by mixing and finally contamination of the preform. These controlled precautions for use by a person skilled in the art are also applicable to other steps of the method. Thus, during sintering, the mold or the matrix used containing the preform will preferably be made of graphite.

A sintered ceramic body obtained from the powder according to the invention advantageously has an electrical resistivity, measured at 25° C. and at atmospheric pressure, of less than 0.2 microOhm·m.

Hot pressing, hot isostatic pressing, or SPS (Spark Plasma Sintering) techniques are particularly suitable.

The following examples are for illustrative purposes only and do not limit the scope of the present invention in any of the aspects described.

### EXAMPLES

### Example 1 (Comparative)

The starting mixture was made with a powder of titanium oxide with a median diameter D₅₀ of 10 μm mainly in a crystallographic form of TiO₂ in rutile form provided by Traxys France (95% purity), a powder of boron oxide B₂O₃ of median diameter D₅₀ equal to 15 μm and a carbon black powder of median diameter D₅₀ of 0.2 μm according to the following respective mass proportions 38.1% TiO₂, 33.2% B₂O₃ and 28.7% C.

A mixture sample was placed in a graphite crucible with dimensions of 6 cm internal diameter, 8 cm external diameter and 8 cm tall. The open crucible is placed in an induction furnace in order to be subjected respectively to a heat treatment at 1600° C. for a plateau duration of 2 hours in an oven in an Argon flow of 1.25 L/min/m³.

The synthesis mixture obtained was ground for 3 minutes in order to obtain a powder with a median size of less than 10 microns.

### Example 2 (According to the Invention)

The starting mixture was made with a powder of titanium oxide with a median diameter D₅₀ of 10 μm mainly in a rutile crystallographic form as in the previous example, a powder of sodium tetraborate (Na₂B₄O₇) of median diameter D₅₀ equal to 50 μm from Sigma Aldrich with purity greater than 99% by mass and a metal aluminum powder with a median diameter D₅₀ of 10 μm from Alfa Aesar with purity greater than 99% by mass, a powder of sodium oxide (Na₂Y) of median diameter D₅₀ of 50 μm from Sigma Aldrich with a purity of greater than 99% by mass, in the following respective mass proportions 23.3%, 29.3%, 26.2% and 21.2%. A mixture sample was placed in a graphite crucible of the same size as the previous example. The open crucible is placed in a tubular furnace in order to be subjected respectively to a heat treatment at 800° C. at a temperature rise of 2° C./minute in a tubular furnace followed by a stage of 2 hours in a furnace in an Argon flow of 1.25 L/min/m³ enclosure of the tubular furnace.

The corresponding balance reaction is:

3TiO₂+1.5Na₂B₄O₇+10Al+3.5Na₂O→TiB₂+10NaAlO₂

or, expressed according to the reaction (3) as a function of the simple oxides TiO₂, B₂O₃ and Na₂O:

TiO₂+B₂O_{3+10/3}Al+5/3Na₂O+TiB₂+10/3NaAlO₂.

The synthesis mixture obtained was ground for 1 minute in order to obtain a powder with a median size of less than 30 microns. The powder obtained was mixed with deionized water according to the following proportion of 1 g of powder for 50 ml of water. This mixture was filtered through passage through a VWR 185 mm 12-15 μm paper to catch the titanium diboride particles. The retentate was dried at 110° C. to obtain the final dry titanium boride powder.

### Example 3 (Comparative)

This example differs from example 2 in that the starting mixture comprises sodium hydroxide granules (NaH content greater than 99%) instead of a sodium oxide powder. The respective proportions by weight of the powders of titanium, sodium tetraborate, and aluminum metal, and the sodium hydroxide granules, were the following 21.9%, 27.6%, 24.7% and 25.8%.

TABLE 1

| | | | |
|---|---|---|---|
| | Example 1 | Example 2 | Example 3 |
| | (compara- | (inven- | (compara- |
| Unit | tive) | tion) | tive) |

recycled raw materials

| | | | | |
|---|---|---|---|---|
| Titanium oxide | D₉₀ μm | 10 | 10 | 10 |
| powder | | 30 | 30 | 30 |
| B₂O₃ powder | D₅₀ μm | 10 | NA | NA |
| | D₉₀ μm | 30 | | |
| Carbon powder | D₅₀ μm | 0.2 | NA | NA |
| | D₉₀ μm | 0.3 | | |
| Aluminum | D₅₀ μm | NA | 5 | 5 |
| powder | D₉₀ μm | | 10 | 10 |
| Sodium | D₅₀ μm | NA | 30 | 30 |
| tetraborate | D₉₀ μm | | 50 | 50 |
| powder | | | | |
| (Na₂B₄O₇) | | | | |
| Alkali oxide | D₅₀ μm | NA | 50 | NA |
| powder Na2O | D₉₀ μm | | 80 | |
| sodium | D₅₀ μm | NA | NA | about 100 |
| hydroxide | | | | |
| granules | | | | |
| (NaOH) | | | | |

Heat treatment

| | | | | |
|---|---|---|---|---|
| Max. | ° C. | 1600 | 800 | 800 |
| temperature | | | | |
| Ramp | ° C./min | 5 | 2 | 2 |
| Plateau | h | 2 | 2 | 2 |
| Atmosphere | | Argon | Argon | Argon |
| Pressure | mbar | Atmos. | Atmos. | Atmos. |
| sweep flow | L/min/m³ | 1.25 | 1.25 | 1.25 |
| rate | of enclosure | | | |
| Material | % | 30 | 20.3 | <5 |
| efficiency | | | | |

N.M not measured;
N.A not applicable = atmospheric pressure

The properties of the final powders obtained are presented in table 2 below. Each powder was mixed with 0.25% of a pressing additive (PVA) and 4.75% of deionized water by mass relative to the mass of powder in order to be cold-pressed under a pressure of 100 bar and to form a cylinder with a diameter of 30 mm and a thickness of 10 mm. After demolding, each cylinder was dried at 11000 for 24 hours and then fired without pressure at a temperature of 1850° C. for 12 h in Argon. The electrical resistivity of each example was measured at room temperature according to the Van der Pauw method at 4 points on an obtained sintered body sample with a diameter of 20-30 mm and a thickness of 2.5 mm.

TABLE 2

| | | |
|---|---|---|
| Example 1 | Example 2 | Example 3 |
| (compara- | (inven- | (compara- |
| tive) | tion) | tive) |

Physical properties of the powder obtained after grinding, 1 min

| | | | |
|---|---|---|---|
| D₅₀ μm | 5.2 | 2.6 | 6.2 |
| D₉₀ μm | 8.9 | 4.9 | 8.6 |
| (D₉₀ − D₁₀)/D₅₀ μm | 1.3 | 0.9 | 1.4 |

Mass % final powder chemistry

| | | | |
|---|---|---|---|
| Ti (%) | 61 | >65 | NM |
| B(%) | 26 | 32.0 | NM |
| O LECO (%) | 0.7 | <1 | 2.5 |
| C LECO (%) | >5% | <0.1 | <0.1 |
| N LECO (%) | 0.1 | <0.1 | <0.1 |
| S LECO (ppm) | 180 | <50 | <50 |
| Fe (ppm) | 785 | <500 | <500 |
| Li + Na + K + Rb + Cs(ppm) | 500 | <500 | >2000 |
| Be + Mg + Ca + Sr + Ba | <500 | <500 | <500 |
| (ppm) | | | |
| P (ppm) | <500 | <500 | <500 |
| Ni-(ppm) | <500 | <500 | <500 |
| Co(ppm) | <500 | <500 | <500 |
| Metallic Si % | <0.5 | <0.5 | <0.5 |
| Metallic Al % | — | <0.5 | >5% |
| Actual density | 4.4 | 4.4 | 4.4 |

Characteristic of the ceramic body obtained

| | | | |
|---|---|---|---|
| Resistivity at 25° C. | 0.20 | 0.16 | >0.5 |
| (micro-ohm · m) | | | |

NM = Not measured

These results of example 2 by difference with comparative example 1 show that it is possible to obtain, according to the method of the invention, a very pure, fine powder without releasing CO and at a lower synthesis temperature. The comparison of example 2 with examples 1 and 3 shows that the raw powder according to the invention is significantly less dispersed, in particular that produced by the method of example 3 based on a soda solution (see D₉₀−D₁₀)/D₅₀).

1. A method for synthesizing a diboride powder MB₂, where M is a chemical element belonging to group 4 of the periodic table, by reducing an oxide of said M, comprising:
preparing a mixture of raw materials comprising:
a) a powder whose mass content of said oxide MO₂ is at least 95% and
b) a powder comprising a boron oxide or a precursor of a boron oxide, the boron content of which, expressed in B₂O₃, is at least 30%; and
c) a metal powder of at least one reducing element R, R being selected from Al, Si, Ti, Zr, Hf, Y, Sc, the lanthanides; and
d) an oxide powder of an alkali element A, having a A₂O mass content of at least 70%, in respective proportions leading to the following balance reaction, expressed according to said MO₂, B₂O₃, R and A₂O:
MO₂+B₂O₃+yR+xA₂O→MB₂+A₂ₓR_{y}O₅₊ₓ (3)
heating said mixture in an enclosure under a rare gas flow, at a temperature above 600° C. and below 1500° C.,
said mixture of raw materials having the following characteristics:
a median particle diameter of said powder comprising the oxide MO₂ is between 1 and 100 microns, and
a median particle diameter of the powder comprising a boron oxide or a boron oxide precursor is between 5 and 200 microns; and
x is greater than or equal to 1
y is greater than 0.5.

2. The method for synthesizing a diboride powder MB₂, according to claim 1, wherein an hydroxyl mass content in the oxide powder of alkali metal element A, calculated in the form of the mass of OH to the alkali metal, is less than 40%.

3. The method for synthesizing a diboride powder MB₂, according to claim 1, wherein the boron oxide or the boron oxide precursor is chosen from sodium metaborate of chemical formula NaBO₂, anhydrous borax of formula Na₂B₄O₇, or other borates.

4. The method for synthesizing a diboride powder MB₂, according to claim 3, wherein the powder comprising boron oxide is an anhydrous alkali borate powder.

5. The method for synthesizing a powder of MB₂, according to claim 1, wherein the median particle diameter of said powder comprising the oxide MO₂, is greater than 7 micrometers and/or less than 50 micrometers.

6. The method for synthesizing a powder of MB₂, according to claim 1, wherein the median particle diameter of said powder comprising the boron oxide, is greater than 30 micrometers and/or less than 100 micrometers.

7. The method for synthesizing a powder of MB₂ according to claim 1, wherein a ratio of the median particle diameter of said powder comprising boron oxide to the median particle diameter of said powder comprising the oxide MO₂, is less than 10 and/or greater than 1.

8. The method for synthesizing a powder of MB₂ according to claim 1, wherein the heating temperature in said enclosure is greater than 700° C. and/or less than 1400° C.

9. The method for synthesizing a powder of MB₂, according to claim 1, wherein the rare gas is a selected from argon or helium.

10. The method for synthesizing a powder of MB₂, according to claim 9, wherein A is the element Na.

11. The method for synthesizing a powder of MB₂, according to claim 10, wherein R is the element Al and/or Si.

12. The method for synthesizing a powder of MB₂, according to claim 1, wherein M is the element Ti, A is the element Na, and R is the element Al and/or Si.

13. A powder comprising more than 95% by weight of the compound MB₂ obtained according to claim 1, M being chosen among Ti, Zr, Hf, a median diameter of which is between 0.5 and 50 micrometers and a chemical composition of which comprises the following elemental mass percents:
elemental oxygen (O): less than 1.3%;
elemental carbon (C): less than 0.5%;
elemental nitrogen (N): less than 0.5%;
elemental sulfur (S): less than 400 ppm;
elemental iron (Fe): less than 0.45%;
elemental nickel (Ni): less than 0.4%;
elemental cobalt (Co): less than 0.4%;
elemental sum of the alkali metals (Li+Na+K+Rb+Cs): less than 1%;
elemental sum of the alkaline earth metals (Be+Mg+Ca+Sr+Ba) less than 1%.
content of element R in metal form: less than 2%, R being at least one element selected from Al, Si, Ti, Zr, Hf, Y, Sc, the lanthanides,
a sum of the other elements being less than 2%.

14. A powder of TiB₂ according to claim 13, the chemical composition of which comprises the following elemental mass percents:
titanium (Ti): greater than 68% and/or less than 72%,
boron (B): greater than 29% and/or less than 33%,
optionally phosphorus (P) less than 0.3%,
metallic aluminum: less than 2%,
metallic silicon; less than 1%.

15. A powder of MB₂ according to claim 13, wherein a ratio (D₉₀−D₁₀)/D₅₀ of equivalent diameter of the particles of the powder is less than 1.5.

16. A mixture comprising between 90% and 99.9% by mass of a MB₂ powder according to claim 13 and between 0.1 and 10% by mass of one or more sintering powders chosen from powders of aluminum diboride, magnesium diboride, tungsten pentaboride, calcium hexaboride, silicon hexaboride, optionally zirconium diboride if M=Ti or Hf.

17. A method for manufacturing a sintered ceramic body, comprising:
a) preparing a starting feedstock including:
the powder of MB₂ according to claim 13,
an aqueous solvent,
optionally, shaping additives, b) shaping the starting feedstock into the form of a preform;
c) removal from the mold after setting or drying;
d) optionally, drying the preform,
e) loading in a furnace and firing the preform under an inert atmosphere.

18. A sintered ceramic body obtained by a method according to claim 17.

19. A method comprising providing a sintered ceramic body according to claim 18 as all or part of a membrane, a shielding or an anti-abrasion coating, a covering or a refractory block, an anode coating or block or a cathode coating or block, a heat exchanger, a metal melting crucible.

20. The method for synthesizing a powder of MB₂, according to claim 1, wherein the mixture of raw materials consists of said a) powder whose mass content of said oxide MO₂ is at least 95%, said b) powder comprising a boron oxide or a precursor of a boron oxide, said c) metal powder, and said d) oxide powder.
